(19) United States
(12) Patent Application Publication
(10) Pub. No.: US 2007/0039217 A1
(43) Pub. Date: Feb. 22, 2007

(54) Vehicle message display device

(76) Inventor: David W. Van Meter, Oklahoma City, OK (US)

Correspondence Address: JAMES T. ROBINSON, 222 E. MAIN STREET, NORMAN, OK, 73069, US

(21) Appl. No.: 11/207,540

(22) Filed: Aug. 19, 2005

(51) Int. Cl. G09F 21/02

(52) U.S. Cl. 40/586

(57) ABSTRACT

A vehicle message display device for delivering messages from a vehicle includes a set of display cards wherein each display card contains text and, optionally, a graphic relating to the text. A spiral binding keeps the set of display cards organized, and tabs with identifying text aid the vehicle occupant in the selection of an appropriate display card.

### BACKGROUND OF THE INVENTION

1. Field of the Invention

This invention relates to a set of display cards for use in communications between vehicles. Certain display cards bear messages used to notify other motorists of vehicle problems and potential safety hazards. Other display cards may notify passers by of a need for gas or other assistance. Still other display cards bear messages which may be nothing more than a form of friendly greeting.

2. Discussion

While traveling on roads and highways, vehicle drivers and passengers often encounter vehicles with problems. One vehicle may have a loose wheel, a low tire, a partially open door, or an open gas cap. Another vehicle may be emitting smoke, while yet another driver may have a flashing turn signal (sometimes also called a “blinker” herein) or a light that isn't illuminated. Many travelers have noticed a coat dragging the pavement or a load which is being lost. Sometimes the driver of the other vehicle is aware of the problem. On other occasions, the driver is not aware of the problem but would take corrective action if the problem were known. Although many drivers have cellular phones, the cellular phone is of no use without a number.

From time to time, almost every driver has run out of gas or been stranded due to a mechanical failure. Cellular phones are helpful in such circumstances, yet some drivers do not have cellular phones or, for long-distance travelers, help may be far away.

Stories abound of road rage and violence committed by one driver towards another. In this environment, the ability to communicate a warm greeting to another driver has value.

A loose wheel is a safety hazard not only to the occupants of the vehicle but also to other drivers on the road. A low tire affects steering and maneuvering capabilities and affects fuel economy. A low tire can come apart if ignored, thereby creating a safety hazard and littering the environment. A smoking car sacrifices fuel economy and pollutes the environment. Even something as minor as a dragging chain could generate a spark and start a fire.

The present invention enables a driver or passenger to communicate with the occupants of another vehicle—to warn of an existing or potential safety problem, to advise of a general vehicle malfunction, or merely to ask for assistance.

### SUMMARY OF THE INVENTION

Applicant's invention provides a set of display cards bearing messages which are useful in communicating with the driver or passengers in another vehicle. The display cards are bound together by spiral binder or by rings and tabbed to facilitate selection of an appropriate message.

### BRIEF DESCRIPTION OF THE DRAWINGS

FIG. 1 is a view of the applicant's invention displayed from a vehicle window.

FIG. 2 is a display card template in accordance with applicant's invention.

FIG. 3 is another display card.

FIG. 4 is another display card.

FIG. 5 is another display card.

FIG. 6 is another display card.

FIG. 7 is another display card.

FIG. 8 is another display card.

FIG. 9 is another display card.

FIG. 10 is another display card.

FIG. 11 is another display card.

FIG. 12 is another display card.

FIG. 13 is another display card.

FIG. 14 is another display card.

FIG. 15 is another display card.

FIG. 16 is another display card.

FIG. 17 is another display card.

FIG. 18 is another display card.

FIG. 19 is another set of display cards according to the applicant's invention.

### DETAILED DESCRIPTION OF THE INVENTION

In the following description of the present invention, like numerals and characters designate like elements throughout the figures of the drawings.

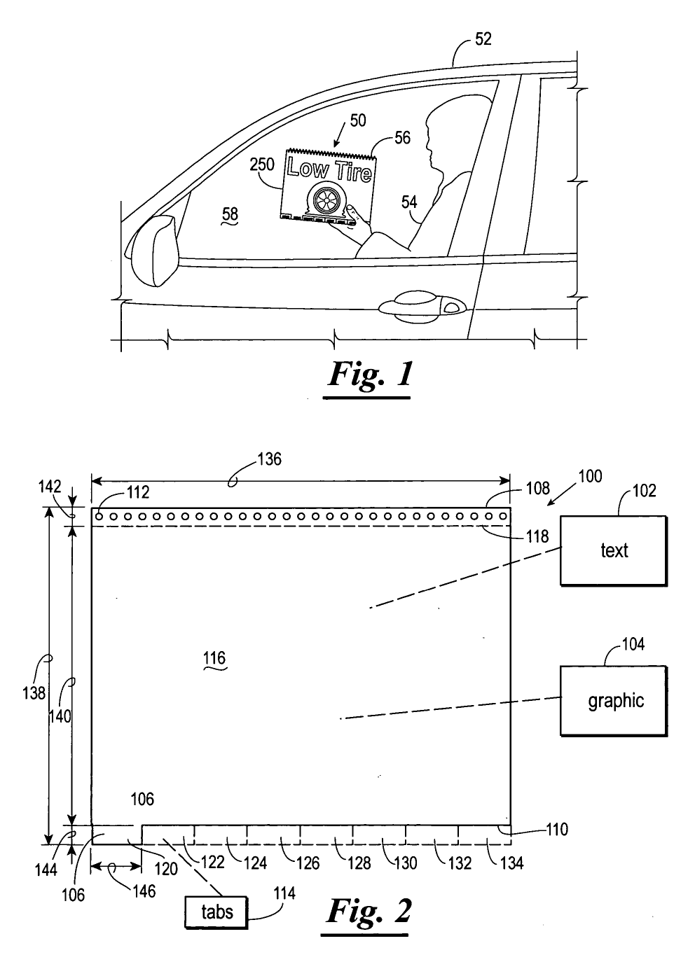

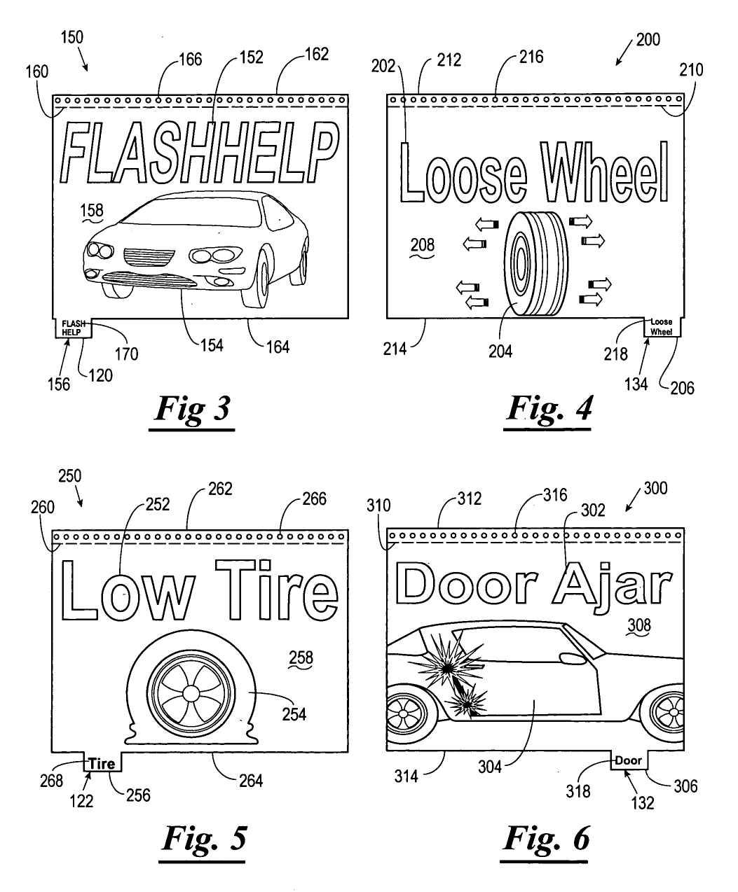

Referring now to FIG. 1, a set of display cards 50 according to applicant's invention is displayed from within vehicle 52 by a driver 54. The set of display cards 50 includes display cards 100, 150, 200, 250, 300, 350, 400, 450, 500, 550, 600, 650, 700, 750, 800, 850, 900 bound together with a binder 56 (see FIGS. 3-17). The display card 250 being displayed is shown in greater detail in FIG. 5.

Still referring to FIG. 1, the display card 250 of the set of display cards 50 is displayed by the driver 54 through the driver's window 58 of the vehicle 52. The display card 250 of the set of display cards 50 may be displayed in any window by the driver or by any passenger (not shown).

Still referring to FIG. 1, it would be understood by one skilled in the art that the binder 56 may be, without limitation, a spiral binder, a three-ring binder, or other binder which permits display of a selected display card.

Referring now to FIG. 2, a display card template 100 has a message text portion 102, a graphic 104, a tab 106, a content area 116, and a binding area 118. The display card template 100 has a top edge 108 and a bottom edge 110. The binding area 118 is located along the top edge 108 and contains binder holes 112 to allow spiral binding of display cards 150, 200, 250, 300, 350, 400, 450, 500, 550, 600, 650, 700, 750, 800, 850, 900. The content area 116 contains the text portion 102 and the graphic 104. The tab 106 is located along the bottom edge 110. The tab 106 contains identifying text 114 to allow the user to easily locate the appropriate display card 150, 200, 250, 300, 350, 400, 450, 500, 550, 600, 650, 700, 750, 800, 850, 900.

Still referring to FIG. 2, it would be understood by one skilled in the art that the message text 102 can show any legible message, and the graphic 104 can display any graphic related to the message text 102. It would further be understood that both the message text 102 and the graphic 104, either independently or cooperatively, communicate a pre-selected message (for example, “You have a low tire” or “I need gas”).

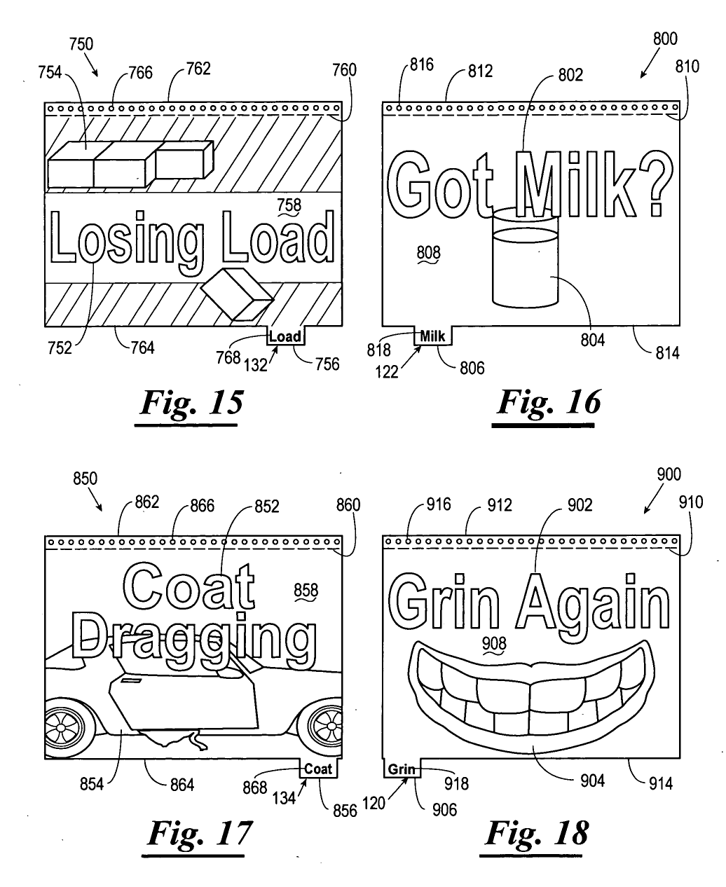

Still referring to FIG. 2, the message text 102 and the graphic 104 can be arranged in any logical fashion within the content area 116 display card template 100. The message text 102 can be superimposed on the graphic 104 (see FIGS. 15 & 17). The binder holes 112 located within the binding area 116 along the top edge 108 of the display card template 100 receive the spiral binder 56.

Still referring to FIG. 2, 8 different tab positions are shown as follows: a first tab position 120, a second tab position 122, a third tab position 124, a fourth tab position 126, a fifth tab position 128, a sixth tab position 130, a seventh tab position 132, and an eighth tab position 134. Each display card 150, 200, 250, 300, 350, 400, 450, 500, 550, 600, 650, 700, 750, 800, 850, 900, 950 has a tab in specific tab position (see FIGS. 3-17).

Still referring to FIG. 2, the display card template 100 includes dimensions for a card width 136, a card height 138, a content area height 140, a binding area height 142, a tab height 144, and a tab width 146. For purposes of illustration, the card width 136 is approximately 12 inches, the card height 138 is approximately 9 inches, the content area height 140 is approximately 8 inches, the binding area height 142 is approximately 0.5 inches, the tab height 144 is approximately 0.5 inches, and the tab width 146 is approximately 1.5 inches.

Referring now to FIG. 3, a display card 150 includes a message text 152, a graphic 154, a tab 156, a content area 158, and a binding area 160. The display card 150 has a top edge 162 and a bottom edge 164. The binding area 160 is located along the top edge 162 and contains binding holes 166. The content area 158 contains the message text 152 and the graphic 154. The tab 156 is located along the bottom edge 164 in the first tab position 120.

Still referring to FIG. 3, the message text 152 on the display card 150 is the phrase “Flash Help” and the graphic 154 is a representation of a car. The tab 156 includes identifying text 170 which is the phrase “Flash Help” to aid the user in locating the display card 150 within the set of display cards 50. The display card 150 serves as a cover when bound together with display cards 200, 250, 300, 350, 400, 450, 500, 550, 600, 650, 700, 750, 800, 850, 900, 950.

Referring now to FIG. 4, a display card 200 includes a message text 202, a graphic 204, a tab 206, a content area 208, and a binding area 210. The display card 200 has a top edge 212 and a bottom edge 214. The binding area 210 is located along the top edge 212 and contains binding holes 216. The content area 208 contains the message text 202 and the graphic 204. The tab 206 is located along the bottom edge 214 in the eighth tab position 134.

Still referring to FIG. 4, the message text 202 on the display card 200 is the phrase “Loose Wheel” and the graphic 204 is a representation of a loose wheel. The tab 206 includes identifying text 218 which is the phrase “Loose Wheel” to aid the user in locating the display card 200 within the set of display cards 50.

Referring now to FIG. 5, a display card 250 includes a message text 252, a graphic 254, a tab 256, a content area 258, and a binding area 260. The display card 250 has a top edge 262 and a bottom edge 264. The binding area 260 is located along the top edge 262 and contains binding holes 266 to allow binding of display card 250. The content area 258 contains the message text 252 and graphic 254. The tab 256 is located along the bottom edge 264 in the second tab position 122.

Still referring to FIG. 5, the message text 252 on the display card 250 is the phrase “Low Tire” and the graphic 254 is representation of a low tire. The tab 256 includes identifying text 268 which consists of the word “Tire” to aid the user in locating the display card 250 within the set of display cards 50.

Referring now to FIG. 6, a display card 300 includes a message text 302, a graphic 304, a tab 306, a content area 308, and a binding area 310. The display card 300 has a top edge 312, and a bottom edge 314. The binding area 310 is located along the top edge 312 and contains binding holes 316. The content area 308 contains the message text 302 and graphic 304. The tab 306 is located along the bottom edge 314 in the seventh tab position 132.

Still referring to FIG. 6, the message text 302 on the display card 300 is the phrase “Door Jar” and the graphic 304 is a representation of an open door. The tab 306 includes identifying text 318 which is the word “Door” to aid the user in locating the display card 300 within the set of display cards 50.

Referring now to FIG. 7, a display card 350 includes a message text 352, a graphic 354, a tab 356, a content area 358, and a binding area 360. The display card 350 has a top edge 362 and a bottom edge 364. The binding area 360 is located along the top edge 362 and contains binding holes 366 to allow binding of the display card 350. The content area 358 contains the message text 352 and the graphic 354. The tab 356 is located along the bottom edge 364 in the third tab position 124.

Still referring to FIG. 7, the message text 352 on the display card 350 is the phrase “Blinker On” and the graphic 354 is a representation of a flashing light. The tab 356 includes identifying text 368 which is the word “Blinker” to aid the user in locating the display card 350 within the set of display cards 50.

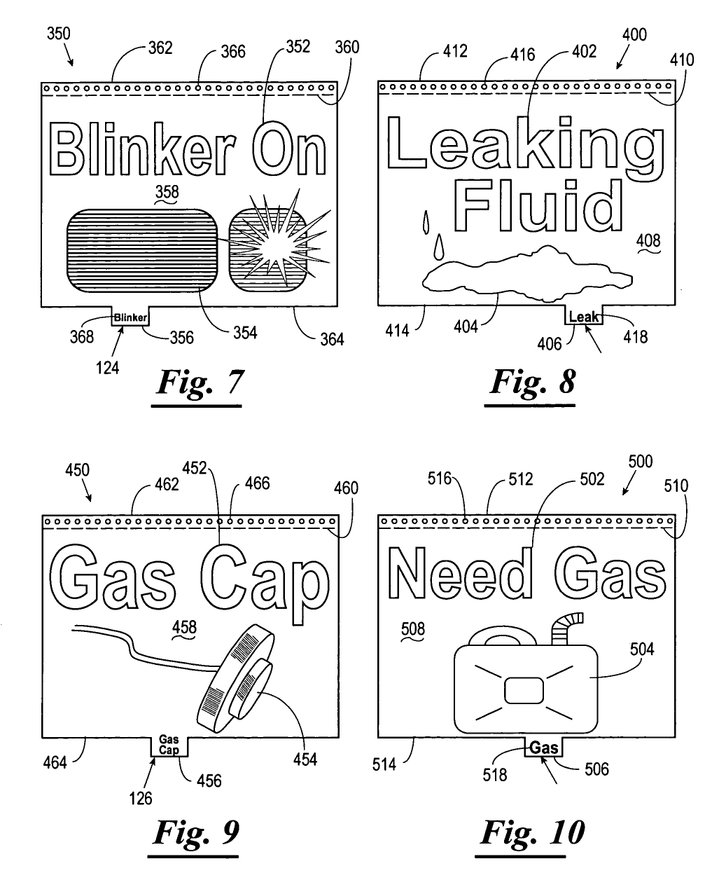

Referring now to FIG. 8, a display card 400 includes a message text 402, a graphic 404, a tab 406, a content area 408, and a binding area 410. The display card 400 has a top edge 412 and a bottom edge 414. The binding area 410 is located along the top edge 412 and contains binding holes 416. The content area 408 contains the message text 402 and graphic 404. The tab 406 is located along the bottom edge 414 in the sixth tab position 130.

Still referring to FIG. 8, the message text 402 on the display card 400 is the phrase “Leaking Fluid” and the graphic 404 is a representation of spilled liquid. The tab 406 includes identifying text 418 which is the word “Leak” to aid the user in locating the display card 400 within the set of display cards 50.

Referring now to FIG. 9, a display card 450 includes a message text 452, a graphic 454, a tab 456, a content area 458, and a binding area 460. The display card 450 has a top edge 462 and a bottom edge 464. The binding area 460 is located along the top edge 462 and contains binding holes 466. The content area 458 contains the message text 452 and graphic 454. The tab 456 is located along the bottom edge 464 in the forth tab position 126.

Still referring to FIG. 9, the message text 452 on the display card 450 is the phrase “Gas Cap” and the graphic 454 is a representation of a gas tank. The tab 456 includes identifying text 458 which is the phrase “Gas Cap” to aid the user in locating the display card 450 within the set of display cards 50.

Referring now to FIG. 10, a display card 500 includes a message text 502, a graphic 504, a tab 506, a content area 508 and a binding area 510. The display card 500 has a top edge 512 and a bottom edge 514. The binding area 510 is located along the top edge 512 and contains binding holes 516. The tab 506 is located along the bottom edge 514 in fifth tab position 128.

Still referring to FIG. 10, the message text 502 on the display card 500 is the phrase “Need Gas” and the graphic 504 is a representation of a gas tank. The tab 506 includes identifying text 518 which is the word “Gas” to aid the user in locating the display card 500 within the set of display cards 50.

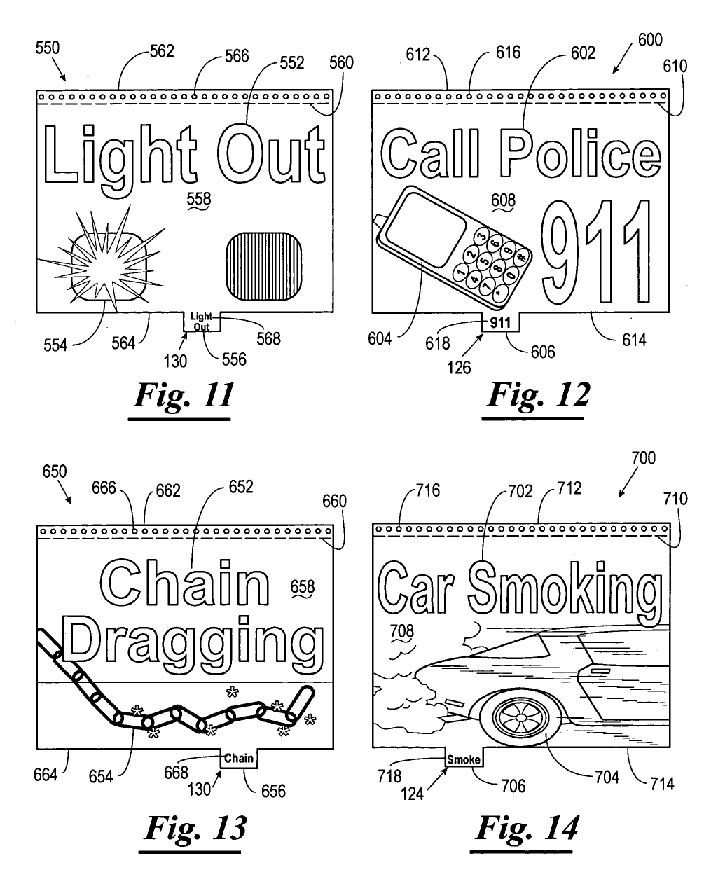

Referring now to FIG. 11, a display card 550 includes a message text 552, a graphic 554, a tab 556, a content area 558 and a binding area 560. The display card 550 has a top edge 562 and a bottom edge 564. The binding area 560 is located along the top edge 562 and contains binding holes 566 to allow binding of the card 550. The tab 556 is located along the bottom edge 564 in sixth tab position 130.

Still referring to FIG. 11, the message text 552 is the phrase “Light Out” and the graphic 554 is a representation of an illuminated light and a non-illuminated light. The tab 556 includes identifying text 568 which is the phrase “Light Out” to aid the user in locating the display card 550 within the set of display cards 50.

Referring now to FIG. 12, a display card 600 includes a message text 602, a graphic 604, a tab 606, a content area 608 and a binding area 610. The display card 600 has a top edge 612 and a bottom edge 614. The binding area 610 is located along the top edge 612 and contains binding holes 616. The tab 606 is located along the bottom edge 614 in the fourth tab position 126.

Still referring to FIG. 12, the message text 602 on the display card 600 is the phrase “Call Police” and the graphic 604 is a representation of a cellular phone and the number 911. The tab 606 includes identifying text 618 which is the number “911” to aid the user in locating the display card 600 within the set of display cards 50.

Referring now to FIG. 13, a display card 650 includes a message text 652, a graphic 654, a tab 656, a content area 658 and a binding area 660. The display card 650 has a top edge 662 and a bottom edge 664. The binding area 660 is located along the top edge 662 and contains binding holes 666. The tab 656 is located along the bottom edge 664 in sixth tab position 130.

Still referring to FIG. 13, the message text 652 on the display card 650 is the phrase “Chain Dragging” and the graphic 654 is a representation of a dragging chain. The tab 656 includes identifying text 668 which is the word “Chain” to aid the user in locating the display card 650 within the set of display cards 50.

Referring now to FIG. 14, a display card 700 includes a message text 702, a graphic 704, a tab 706, a content area 708 and a binding area 710. The display card 700 has a top edge 712 and a bottom edge 714. The binding area 710 is located along the top edge 712 and contains binding holes 716. The tab 706 is located along the bottom edge 714 in the third tab position 124.

Still referring to FIG. 14, the message text 702 on the display card 700 is the phrase “Car Smoking” and the graphic 704 is a representation of a smoking car. The tab 706 includes identifying text 718 which is the word “Smoke” to aid the user in locating the display card 700 within the set of display cards 50.

Referring now to FIG. 15, a display card 750 includes a message text 752, a graphic 754, a tab 756, a content area 758 and a binding area 760. The display card 750 has a top edge 762 and a bottom edge 764. The binding area 760 is located along the top edge 762 and contains binder holes 766. The tab 756 is located along the bottom edge 764 in the seventh tab position 132.

Still referring to FIG. 15, the message text 752 on the display card 750 is the phrase “Losing Load” and the graphic 754 is a representation of a falling load. The tab 756 includes identifying text 768 which is the word “Load” to aid the user in locating the display card 750 within the set of display cards 50.

Referring now to FIG. 16, a display card 800 includes a message text 802, a graphic 804, a tab 806, a content area 808 and a binding area 810. The display card 800 has a top edge 812 and a bottom edge 814. The binding area 810 is located along the top edge 812 and contains binding holes 816. The tab 806 is located along the bottom edge 814 in the second tab position 122.

Still referring to FIG. 16, the message text 802 on the display card 800 is the phrase “Got Milk?” and the graphic 804 is a representation of a glass of milk. The tab 806 includes identifying text 818 which is the word “Milk” to aid the user in locating the display card 800 within the set of display cards 50.

Referring now to FIG. 17, a display card 850 includes a message text 852, a graphic 854, a tab 856, a content area 858 and a binding area 860. The display card 850 has a top edge 862 and a bottom edge 864. The binding area 860 is located along the top edge 862 and contains binding holes 866. The tab 856 is located along the bottom edge 864 in tab position 8 132.

Still referring to FIG. 17, the message text 852 on the display card 850 is the phrase “Coat Dragging” and the graphic 854 is a representation of a dragging coat. The tab 856 includes identifying text 868 which is the word “Coat” to aid the user in locating the display card 850 within the set of display cards 50.

Referring now to FIG. 18, a display card 900 includes a message text 902, a graphic 904, a tab 906, a content area 908 and a binding area 910. The display card 900 has a top edge 912 and a bottom edge 914. The binding area 910 is located along the top edge 912 and contains binding holes 916. The tab 906 is located along the bottom edge 914 in first tab position 120.

Still referring to FIG. 18, the message text 902 on the display card 900 is the phrase “Grin Again” and the graphic 904 is a representation of a wide grin. The tab 906 includes identifying text 918 which is the word “Grin” to aid the user in locating the display card 900 within the set of display cards 50.

Referring now to FIGS. 3-18, the tab positions of the display cards 150, 200, 250, 300, 350, 400, 450, 500, 550, 600, 650, 700, 750, 800, 850, 900 allow for select cards either to be attached to each other back to back or, if desired to minimize the thickness of the set of display cards 50, the display cards can be printed on opposite sides of the same print media. When the display cards 150, 200, 250, 300, 350, 400, 450, 500, 550, 600, 650, 700, 750, 800, 850, 900 are bound together the tabs 156, 206, 256, 306, 356, 406, 456, 506, 556, 606, 656, 706, 756, 806, 856, 906 are arranged progressively from left to right (see FIGS. 3-17). The display card 150 and the display card 200 can be attached back to back so the tabs 156 and 206 align to form one double-sided tab. The following display cards may be attached together resulting in tab alignment: display card 250 and display card 300, display card 350 and display card 400, display card 450 and display card 500, display card 550 and display card 600, display card 650 and display card 700, display card 750 and display card 800, display card 850 and display card 900.

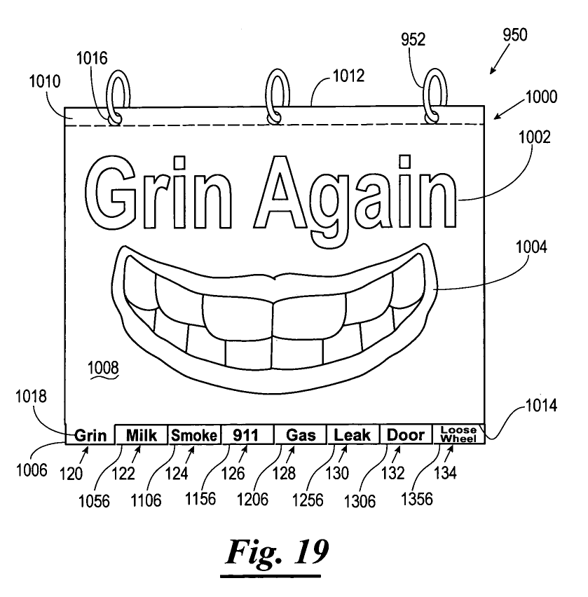

Referring now to FIG. 19, another set of display cards 950 uses rings 952 to bind together individual display cards 1000, 1050, 1100, 1150, 1200, 1250, 1300, 1350. The display card 1000 includes a message text 1002, a graphic 1004, a tab 1006, a content area 1008, a binding area 1010. The display card 1000 has a top edge 1012 and a bottom edge 1014. The binding area 1010 is located along the top edge and contains three binding holes 1016 which receive the rings 952. The content area 1008 contains the message text 1002 and the graphic 1004. The tab 1006 is located along the bottom edge 1014 in the first tab position 120. It will be understood by one skilled in the art that the message text and graphic are the same as the display card 900 shown in FIG. 18.

Still referring to FIG. 19, the display card 1050 has a tab 1056 (“Milk”) visible in the second tab position 122. The display card 1100 has a tab 1106 (“Smoke”) visible in the third tab position 124. The display card 1150 has a tab 1156 (“911”) in the fourth tab position 126. The display card 1200 has a tab 1206 (“Gas”) in the fifth tab position 128. The display card 1250 has a tab 1256 (“Leak”) in the sixth tab position 130. The display card 1300 has a tab 1306 (“Door”) in the seventh tab position 132. The display card 1350 has a tab 1356 (“Lose Wheel”) in the eighth tab position 134. Only the tabs 1006, 1056, 1106, 1156, 1206, 1256, 1306, 1356 are visible because the content area and the binding area of each of the cards 1000, 1050, 1100, 1150, 1200, 1250, 1300 are hidden behind the content area 1008 and the binding area 1010 of the display card 1000 (“Grin Again”).

The set of display cards according to the applicant's invention can be of any convenient size. For the purpose illustration and visibility, the set of display cards described are 9 inches by 12 inches. It would be understood by one skilled in the art that the dimensions could be larger or smaller as long as the message text can be read from a nearby car or person passing-by.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

I claim:

1. A vehicle message display device for delivering a message from a vehicle, the vehicle message display device comprising:
a first display card having a top edge and a bottom edge, the first display card being further characterized as having a first display card binding area adjacent the top edge and a first display card content area, wherein the first display card content area contains the text “Loose Wheel”;
a second display card having a top edge and a bottom edge, the second display card being further characterized as having a second display card binding area adjacent the top edge and a second display card content area, wherein the second display card content area contains the text “Low Tire”;
a third display card having a top edge and a bottom edge, the third display card being further characterized as having a third display card binding area adjacent the top edge and a third display card content area, wherein the third display card content area contains the text “Door Ajar”;
a cover;
wherein the first display card, the second display card, the third display card, and the cover are substantially the same size; and
binding means for binding the cover, the first display card, the second display card, and the third display card together along their respective binding areas, so that a selected display card can be displayed from the vehicle and the remaining cards are attached to the card being displayed.

2. The device of claim 1, further comprising:
a first display card graphic located within the first display card content area, the first display card graphic relating to the “Loose Wheel” text;
a second display card graphic located within the second display card content area, the second display card graphic relating to the “Low Tire” text; and
a third display card graphic located within the third display card content area, the third display card graphic relating to the “Door Ajar” text.

3. The device of claim 2, wherein the first display card graphic is a representation of a wheel, the second display card graphic is a representation of a low tire, and the third display card graphic is a representation of an open door on an automobile.

4. The device of claim 1, wherein each display card has a tab located at the display card bottom edge.

5. The device of claim 2, wherein each display card has a tab located at the display card bottom edge.

6. The device of claim 3, wherein each display card has a tab located at the display card bottom edge.

7. The device of claim 1, wherein the binding means further comprises a spiral spine threaded through aligned spiral binding holes located in the binding area of each display card.

8. The device of claim 1, wherein the binding means further comprises three rings threaded through aligned holes located in the binding area of each display card.

9. The device of claim 1, further comprising:
a fourth display card having a top edge and a bottom edge, the fourth display card being further characterized as having a fourth display card binding area adjacent the top edge and a fourth display card content area, wherein the fourth display card content area contains the text “Blinker On”;
a fifth display card having a top edge and a bottom edge, the fifth display card being further characterized as having a fifth display card binding area adjacent the top edge and a fifth display card content area, wherein the fifth display card content area contains the text “Leaking Fluid”;
a sixth display card having a top edge and a bottom edge, the sixth display card being further characterized as having a sixth display card binding area adjacent the top edge and a sixth display card content area, wherein the sixth display card content area contains the text “Gas Cap”;
a seventh display card having a top edge and a bottom edge, the seventh display card being further characterized as having a seventh display card binding area adjacent the top edge and a seventh display card content area, wherein the seventh display card content area contains the text “Need Gas”;
an eighth display card having a top edge and a bottom edge, the eighth display card being further characterized as having an eighth display card binding area adjacent the top edge and an eighth display card content area, wherein the eighth display card content area contains the text “Light Out”;
a ninth display card having a top edge and a bottom edge, the ninth display card being further characterized as having a ninth display card binding area adjacent the top edge and a ninth display card content area, wherein the ninth display card content area contains the text “Call Police”;
a tenth display card having a top edge and a bottom edge, the tenth display card being further characterized as having a tenth display card binding area adjacent the top edge and a tenth display card content area, wherein the tenth display card content area contains the text “Chain Dragging”;
an eleventh display card having a top edge and a bottom edge, the eleventh display card being further characterized as having an eleventh display card binding area adjacent the top edge and an eleventh display card content area, wherein the eleventh display card content area contains the text “Car Smoking”;
a twelfth display card having a top edge and a bottom edge, the twelfth display card being further characterized as having a twelfth display card binding area adjacent the top edge and a twelfth display card content area, wherein the twelfth display card content area contains the text “Losing Load”;
a thirteenth display card having a top edge and a bottom edge, the thirteenth display card being further characterized as having a thirteenth display card binding area adjacent the top edge and a thirteenth display card content area, wherein the thirteenth display card content area contains the text “Got Milk?”;
a fourteenth display card having a top edge and a bottom edge, the fourteenth display card being further characterized as having a fourteenth display card binding area adjacent the top edge and a fourteenth display card content area, wherein the fourteenth display card content area contains the text “Coat Dragging”; and
a fifteenth display card having a top edge and a bottom edge, the fifteenth display card being further characterized as having a fifteenth display card binding area adjacent the top edge and a fifteenth display card content area, wherein the fifteenth display card content area contains the text “Grin Again”.

10. The device of claim 9, further comprising:
a fourth display card graphic located within the fourth display card content area, the fourth display card graphic relating to the “Blinker On” text;
a fifth display card graphic located within the fifth display card content area, the fifth display card graphic relating to the “Leaking Fluid” text;
a sixth display card graphic located within the sixth display card content area, the sixth display card graphic relating to the “Gas Cap” text;
a seventh display card graphic located within the seventh display card content area, the seventh display card graphic relating to the “Need Gas” text;
an eighth display card graphic located within the eighth display card content area, the display card graphic relating to the “Light Out” text;
a ninth display card graphic located within the ninth display card content area, the ninth display card graphic relating to the “Call Police” text;
a tenth display card graphic located within the tenth display card content area, the tenth display card graphic relating to the “Chain Dragging” text;
an eleventh display card graphic located within the eleventh display card content area, the eleventh display card graphic relating to the “Car Smoking” text;
a twelfth display card graphic located within the twelfth display card content area, the twelfth display card graphic relating to the “Losing Load” text;
a thirteenth display card graphic located within the thirteenth display card content area, the thirteenth display card graphic relating to the “Got Milk?” text;
a fourteenth display card graphic located within the fourteenth display card content area, the fourteenth display card graphic relating to the “Coat Dragging” text; and
a fifteenth display card graphic located within the fifteenth display card content area, the fifteenth display card graphic relating to the “Grin Again” text.

11. The device of claim 10, wherein the fourth display card graphic is a representation of a glowing vehicle blinker, the fifth display card graphic is a representation of spilled liquid, the sixth display card graphic is a representation of a gas cap, the seventh display card graphic is a representation of a gas can, the eighth display card graphic is a representation of an illuminated light adjacent a non-illuminated light, the ninth display card graphic is a representation of a cell phone adjacent an enlarged “911”, the tenth display card graphic is a representation of a dragging chain, the eleventh display card graphic is a representation of a car with smoke billowing from its exhaust, the twelfth display card graphic is a representation of a falling load, the thirteenth display card graphic is a representation of a glass of milk, the fourteenth display card graphic is a representation of a coat protruding below an automobile door, and the fifteenth display card graphic is a representation of a wide grin.

12. The device of claim 11, wherein the cover has a top edge and a bottom edge, the cover being further characterized as having a cover binding area adjacent the cover top edge and a cover content area wherein the cover content area, and wherein the cover and each display card are further characterized as having eight spaced tab positions from left to right along the bottom edge of the display card and cover, wherein the first tab position is leftmost along the bottom edge of the display card and cover, the eighth tab position is rightmost along the bottom edge of the display card and cover, and the second, third, fourth, fifth, sixth, and seventh tab positions are evenly spaced, from left to right, between the first tab position and the eighth tab position, and, further:
wherein the cover has a tab located in the first tab position and the first display card has a tab located in the eighth tab position so that, when the cover and the first display card are attached to the binding means back to back, the cover tab aligns with the first display card tab;
wherein the second display card has a tab located in the second tab position and the third display card has a tab located in the seventh tab position so that, when the second display card and the third display card are attached to the binding means back to back, the second display card aligns with the third display card tab;
wherein the fourth display card has a tab located in the third tab position and the fifth display card has a tab located in the sixth tab position so that, when the fourth display card and the fifth display card are attached to the binding means back to back, the fifth display card tab aligns with the sixth display card tab;
wherein the sixth display card has a tab located in the fourth tab position and the seventh display card has a tab located in the fifth tab position so that, when the sixth display card and the seventh display card are attached to the binding means back to back, the sixth display card tab aligns with the seventh display card tab;
wherein the eighth display card has a tab located in the fifth tab position and the ninth display card has a tab located in the fourth tab position so that, when the eighth display card and the ninth display card are attached to the binding means back to back, the eighth display card tab aligns with the ninth display card tab;
wherein the tenth display card has a tab located in the sixth tab position and the eleventh display card has a tab located in the third tab position so that, when the tenth display card and the eleventh display card are attached to the binding means back to back, the tenth display card tab aligns with the eleventh display card tab;
wherein the twelfth display card has a tab located in the seventh tab position and the thirteenth display card has a tab located in the second tab position so that, when the twelfth display card and the thirteenth display card are attached to the binding means back to back, the twelfth display card tab aligns with the thirteenth display card tab; and
wherein the fourteenth display card has a tab located in the eighth tab position and the fifteenth display card has a tab located in the first tab position so that, when the fourteenth display card and the fifteenth display card are attached to the binding means back to back, the fourteenth display card tab aligns with the fifteenth display card tab.

13. The device of claim 12:
wherein the cover tab has printed thereon identifying text consisting of the phrase “Flash Help;”
wherein the first display card tab has printed thereon identifying text consisting of the phrase “Loose Wheel;”
wherein the second display card tab has printed thereon identifying text consisting of the word “Tire;”
wherein the third display card tab has printed thereon identifying text consisting of the word “Door;”
wherein the fourth display card tab has printed thereon identifying text consisting of the word “Blinker;”
wherein the fifth fourth display card tab has printed thereon identifying text consisting of the word “Leak;”
wherein the sixth display card tab has printed thereon identifying text consisting of the phrase “Gas Cap;”
wherein the seventh display card tab has printed thereon identifying text consisting of the word “Gas;”
wherein the eighth display card tab has printed thereon identifying text consisting of the word “Gas;”
wherein the ninth display card tab has printed thereon identifying text consisting of the phrase “Light Out;”
wherein the tenth display card tab has printed thereon identifying text consisting of the text “911;”
wherein the eleventh display card tab has printed thereon identifying text consisting of the word “Chain;”
wherein the twelfth display card tab has printed thereon identifying text consisting of the word “Smoke;”
wherein the thirteenth display card tab has printed thereon identifying text consisting of the word “Load;”
wherein the fourteenth display card tab has printed thereon identifying text consisting of the word “Milk;” and
wherein the fifteenth display card tab has printed thereon identifying text consisting of the word “Grin;”

14. The device of claim 13, wherein the binding means further comprises a spiral spine threaded through aligned spiral binding holes located in the binding area of each display card.

15. The device of claim 13, wherein the binding means further comprises three rings threaded through aligned holes located in the binding area of each display card.

16. The device of claim 1, wherein the cover is laminated back-to-back to the first display card and the second display card is laminated back-to-back to the third display card.

17. The device of claim 1, wherein the contents of the second display card appear on the back of the cover and the contents of the third display card appear on the back of the second display card.

18. The device of claim 12 wherein:
the cover card is laminated back-to-back to the first display card;
the second display card is laminated back-to-back to the third display card;
the fourth display card is laminated back-to-back to the fifth display card;
the sixth display card is laminated back-to-back to the seventh display card;
the eighth display card is laminated back-to-back to the ninth display card;
the tenth display card is laminated back-to-back to the eleventh display card;
the twelfth display card is laminated back-to-back to the thirteenth display card;
the fourteenth display card is laminated back-to-back to the fifteenth display card; and
the sixteenth display card is laminated back-to-back to the seventeenth display card.

19. The device of claim 12, wherein:
the contents of the second display card are printed on the back of the cover;
the contents of the fourth display card are printed on the back of the third display card;
the contents of the sixth display card are printed on the back of the fifth display card;
the contents of the eighth display card are printed on the back of the seventh display card;
the contents of the tenth display card are printed on the back of the ninth display card;
the contents of the twelfth display card are printed on the back of the eleventh display card;
the contents of the fourteenth display card are printed on the back of the thirteenth display card; and
the contents of the sixteenth display card are printed on the back of the fifteenth display card.
